(19) United States
(12) Patent Application Publication
(10) Pub. No.: US 2026/0008903 A1
(43) Pub. Date: Jan. 8, 2026

(54) POLYTHIOL COMPOSITION AND USE THEREOF

(71) Applicant: EFIRM NEW MATERIAL CO., LTD., Binzhou (CN)

(72) Inventors: Zhili SUN, Binzhou (CN); Weihua CUI, Binzhou (CN); Hairong ZHENG, Binzhou (CN); Xianjun YI, Binzhou (CN); Hongqi LIU, Binzhou (CN); Jingjing QIU, Binzhou (CN); Xuefei MA, Binzhou (CN)

(73) Assignee: EFIRM NEW MATERIAL CO., LTD., Binzhou (CN)

(21) Appl. No.: 19/135,390

(22) PCT Filed: Apr. 1, 2024
(86) PCT No.: PCT/CN2024/085152

§ 371 Date: Jun. 4, 2025

(30) Foreign Application Priority Data
Sep. 28, 2023 (CN) 202311275465.3

(51) Int. Cl. C08K 5/372; C08G 18/02

(52) U.S. Cl. CPC C08K 5/372; C08G 18/02

(57) ABSTRACT

A polythiol composition and the use thereof are provided. The polythiol composition includes a first polythiol compound having a structure as shown in formula I and a second polythiol compound having a structure as shown in formula II. The polythiol composition can significantly improve the material leakage condition after pouring during the preparation of an optical material; by further defining the mass ratio of the first polythiol compound having the structure as shown in formula I to the second polythiol compound having the structure as shown in formula II, the polythiol composition can significantly reduce the material leakage rate after pouring; in addition, the reduction in terms of the refractive index is not significant, such that the use performance of the polythiol is improved.

### CROSS REFERENCE TO THE RELATED APPLICATIONS

This application is the national phase entry of International Application No. PCT/CN2024/085152, filed on Apr. 1, 2024, which is based upon and claims priority to Chinese Patent Application No. 202311275465.3, filed on Sep. 28, 2023, the entire contents of which are incorporated herein by reference.

### TECHNICAL FIELD

The present invention relates to the technical field of optical materials, and in particular relates to a polythiol composition and the use thereof.

### BACKGROUND

Plastic transparent materials have the advantages of light weight, strong toughness, easy coloration, etc., and are commonly used in the preparation of various optical materials in recent years. For example, they are applied to the field of glasses and lenses requiring high transparency, low yellow index, high heat resistance, high strength, and high refractive index and Abbe number. A high refractive index allows the lens to be thinner, and a high Abbe number decreases the chromatic aberration of the lens.

A polythiourethane-based optical resin material with the above-mentioned excellent properties is an important research object in recent years. Such resin material is mainly prepared from a polythiol compound and a polyisocyanate as raw materials.

Currently, most polythiourethane-based optical resin materials are prepared from a polythiol compound having the following formula (chemical name: 2,3-dithio(2-mercapto)-1-propanethiol) and a polyisocyanate, and the obtained resin is a thermosetting resin.

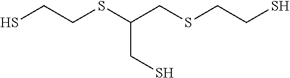 [SMILES: SCCSCC(CS)SCCS]

The specific preparation method includes that: first use the adhesive tape to bond two glass molds together, leaving a certain distance between the two molds, and generally the center distance is about 2 mm. Mix and degas polythiol, polyisocyanate and additives to obtain the prepolymer, uncover the adhesive tape of the molds, and pour the prepolymer into the molds, bond the adhesive tape, and carry out curing and demolding can obtain the resin material.

In practical application, the poured mold will have material leakage from the pouring port during the placement, and the material leaks to the outer surface of the glass molds. After the curing, the leaked material will be solidified as a hard resin to stick onto the mold surface, which is difficult to clean up, affects the production efficiency, and causes more serious situations. When the material leakage is serious, the material in the mold may be exposed, and a small amount of external air may enter the mold, causing bubbles to appear at the edge of the pouring port for the cured lens, thereby affecting the percent of pass for the lens.

### SUMMARY

In view of this, the present invention provides a polythiol composition and the use thereof to solve the technical problem, so that the material leakage condition after pouring during the preparation of an optical material can be significantly improved.

The present invention provides a polythiol composition, including a first polythiol compound having a structure as shown in formula I and a second polythiol compound having a structure as shown in formula II;

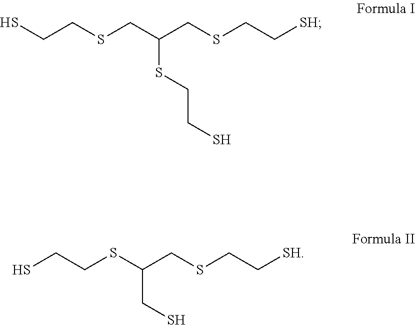 [SMILES: SCCSCC(CSCCS)SCCS ; SCCSCC(CS)SCCS]

Preferably, a mass ratio of the first polythiol compound having the structure as shown in formula I and the second polythiol compound having the structure as shown in formula II is (0.4-5.0):100.

The present invention also provides an optical material, which is prepared from a raw material including a material a and a catalyst.

The material a includes a polythiol composition and a polyisocyanate.

The polythiol composition is the polythiol composition described above.

Preferably, the polyisocyanate includes at least one of tetramethylene diisocyanate, hexamethylene diisocyanate, cyclohexane diisocyanate, 4,4′-diisocyanate dicyclohexylmethane, isophorone diisocyanate, norbornane diisocyanate, xylylene diisocyanate, hydrogenated xylylene diisocyanate, tetramethyl m-xylylene diisocyanate, dithiodipropyl diisocyanate, dithiodiethyl diisocyanate, 2,5-diisocyanatomethylthiophene, 2,5-diisocyanatomethyl-1,4-dithiane, 2,5-diisocyanato-1,4-dithiane, thiodihexyl diisocyanate, thiodipropyl diisocyanate, bis(isocyanatomethyl)adamantane, bis(isocyanatomethyl)tetrahydrothiophene, 2,6-bis(isocyanatomethyl)naphthalene, 1,5-naphthalene diisocyanate, diethylene diisocyanate, trimethylhexamethylene diisocyanate, lysine triisocyanate, tolylene diisocyanate, o-tolidine diisocyanate, diphenylmethane diisocyanate, diphenyl ether diisocyanate, triphenylmethane triisocyanate.

Preferably, a molar ratio of —SH in the polythiol composition to —NCO in the polyisocyanate is 0.8:1 to 1.2:1.

Preferably, the material a further includes a third polythiol compound.

The third polythiol compound includes at least one of 4,7-dimercaptomethyl-1,11-dimercapto-3,6,9-trithiaundecane, 4,8-dimercaptomethyl-1, 11-dimercapto-3,6,9-trithiaundecane, 5.7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis(3-mercaptopropionate), pentaerythritoltetrakismercaptopropionate, 1,2-dimercaptocyclohexane, 1,1,1-tris(mercaptomethyl)propane, 1,4-buthanediolbis(3 -mercaptopropionate), 1,3-dimercaptocyclohexane, trimethylolpropanetrismercaptoacetate, 1,4-dimercaptocyclohexane, 1,3-bis(mercaptomethyl)cyclohexane,1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl)propane, 4,4′-dimercaptobiphenyl, bis(4-mercaptophenyl)ether, bis(4-mercaptomethylphenyl)methane, 1,1,3,3-tetrakismercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole and 3,4-thiophenedithiol.

A mass ratio of the polythiol composition to the third polythiol compound is (0.5:1)-(2:1).

Preferably, the catalyst includes at least one of dibutyltin dilaurate, dibutyltin dichloride, dibutyltin oxide, or stannous octanoate.

A mass ratio of the catalyst to the material a is (0.005-0.2):100.

Preferably, the raw material for preparing the optical material further includes an auxiliary agent.

The auxiliary agent includes at least one of a release agent, an ultraviolet absorber and a toner.

The release agent is polyphosphate.

The present invention also provides a method for preparing the optical material described above, including the steps of:

Mixing the raw material including the material a and the catalyst, and polymerizing and curing to obtain an optical material;

The material a includes a polythiol composition and a polyisocyanate.

The polythiol composition is the polythiol composition described above.

Preferably, the method for preparing the optical material including the steps of:
A) Stirring and dissolving the polyisocyanate, catalyst and release agent to obtain a first mixed solution;
B) Uniformly mixing the first mixed solution, the polythiol composition and the third polythiol compound, and degassing to obtain a second mixed solution;
C) Pouring the second mixed solution into a mold, and polymerizing and curing to obtain the optical material;

The polythiol composition is the polythiol composition described above.

The present invention provides a polythiol composition, including a first polythiol compound having a structure as shown in formula I and a second polythiol compound having a structure as shown in formula II. The polythiol composition provided in the present invention can significantly improve the material leakage condition after pouring during the preparation of an optical material, because compared with the second polythiol compound, the first polythiol compound has a longer molecular chain and a higher self-viscosity, which can increase the viscosity of the prepolymer, and meanwhile, the first polythiol compound has less steric hindrance in reacting with polyisocyanate, so that the reaction activity is higher, and the prepolymerization degree is deeper, which also increases the viscosity of the prepolymer. By appropriately increasing the viscosity, the prepolymer is not easy to leak from the pouring port. At the same time, since the first polythiol compound and the second polythiol compound have similar structures, the chemical properties of the two are relatively close, and the mechanical properties of the resin material are not significantly affected after addition. However, since the sulfur content of the first polythiol compound is low and the refractive index is slightly low, the refractive index of the resin lens prepared after adding the first polythiol compound is slightly decreased, so it is necessary to control the amount of addition to minimize the material leakage rate while ensuring that the refractive index of the resin lens is qualified.

### DETAILED DESCRIPTION OF THE EMBODIMENTS

The technical solution of the present invention will be clearly and completely described below in conjunction with the embodiments of the present invention. Obviously, the described embodiments are only part of the embodiments for the present invention, rather than all. Based on the embodiments in the present invention, all other embodiments obtained by ordinary technicians in this field without making creative work are within the protection scope of the present invention.

The present invention provides a polythiol composition, including a first polythiol compound having a structure as shown in formula I and a second polythiol compound having a structure as shown in formula II;

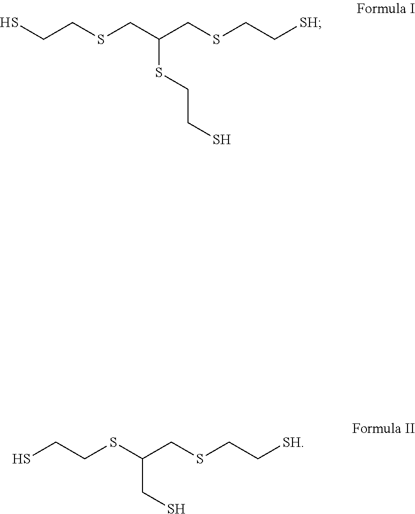 [SMILES: SCCSCC(CSCCS)SCCS ; SCCSCC(CS)SCCS]

In some embodiments of the present invention, a mass ratio of the first polythiol compound having the structure as shown in formula I and the second polythiol compound having the structure as shown in formula II is (0.4-5.0):100; preferably (0.8-2.0):100; for example, 0.4%, 0.6%, 0.8%, 1.0%, 1.5%, 2.0%, 2.5%, 3.0%, 4.0% and 5.0%.

The present invention has no particular limitations on the source of the first polythiol compound having the structure as shown in formula I.

In some embodiments of the present invention, the method for preparing the first polythiol compound having the structure as shown in formula I including the following steps of:
a1) Dripping sodium hydroxide solution into mercaptoethanol (2-mercaptoethanol), then stirring at 30-40° C.;
a2) After dripping 1,2,3-trichloropropane, reacting at 30-50° C.; and during the addition of 1,2,3-trichloropropane, the temperature is controlled below 50° C.;
a3) After adding hydrochloric acid solution and thiourea, heating to above 110° C. for the reflux reaction;
a4) Cooling to below 30° C., adding the ammonia solution, and heating to 60-70° C. for reaction to obtain a first polythiol compound having the structure as shown in formula I.

### In Step a1):

The mass concentration of the sodium hydroxide solution is 30%- 35%, such as 32%. The solvent of the sodium hydroxide solution is water.

The molar ratio of the mercaptoethanol to the sodium hydroxide is (1-2): (1-2), such as 1.5:1.55.
The stirring temperature is 45° C.; and the stirring time is 20-40 min, such as 30 min.

### In Step a2):

The molar ratio of the 1,2,3-trichloropropane to the mercaptoethanol is (0.3-0.7): (1-2), such as 0.5:1.5.
The reaction temperature is 40° C.; and the reaction time is 1.5-2.5 h, such as 2 h.

### In Step a3):

The mass concentration of the hydrochloric acid solution is 35%- 40%, such as 37%.
The molar ratio of the hydrochloric acid to the mercaptoethanol is (1.5-2.5): (1-2), such as 2:1.5.

The molar ratio of the thiourea to the mercaptoethanol is (1:1)-(2:1), such as 1.6:1.5 (i.e. 1.1:1).
The temperature of the reflux reaction is 120° C.; and the time is 3-5 h, such as 4 h.

### In Step a4):

Cooling to 25° C.
The mass concentration of the ammonia solution is 15%- 20%, such as 18%.
The molar ratio of the ammonia to the mercaptoethanol is (2-3): (1-2), such as 2.5:1.5.
The reaction temperature is 65° C. and the reaction time is 2-4 h, such as 3 h.

After the reaction, the method further includes: separating the liquid, and the obtained lower-layer crude product is washed with ethanol, and then desolventized in vacuum to obtain a first polythiol compound having the structure as shown in formula I. The ethanol has the same mass as the lower-layer crude product. The number of washings is not less than 3 times, and specifically can be 3 times.

The present invention has no particular limitation on the source of the second polythiol compound represented by formula II, and it can be a commercially available one.

In some embodiments of the present invention, the polythiol composition is obtained by mixing the first polythiol compound having the structure as shown in formula I and the second polythiol compound having the structure as shown in formula II.

The present invention also provides an optical material, which is prepared from a raw material including a material a and a catalyst.

The material a includes a polythiol composition and a polyisocyanate.

The polythiol composition is the polythiol composition described above.

In some embodiments of the present invention, the polyisocyanate includes at least one of tetramethylene diisocyanate, hexamethylene diisocyanate, cyclohexane diisocyanate, 4,4′-diisocyanate dicyclohexylmethane, isophorone diisocyanate, norbornane diisocyanate, xylylene diisocyanate, hydrogenated xylylene diisocyanate, tetramethyl m-xylylene diisocyanate, dithiodipropyl diisocyanate, dithiodiethyl diisocyanate, 2,5-diisocyanatomethylthiophene, 2,5-diisocyanatomethyl-1,4-dithiane, 2,5-diisocyanato-1,4-dithiane, thiodihexyl diisocyanate, thiodipropyl diisocyanate, bis(isocyanatomethyl)adamantane, bis (isocyanatomethyl) tetrahydrothiophene, 2,6-bis(isocyanatomethyl)naphthalene, 1,5-naphthalene diisocyanate, diethylene diisocyanate, trimethylhexamethylene diisocyanate, lysine triisocyanate, tolylene diisocyanate, o-tolidine diisocyanate, diphenylmethane diisocyanate, diphenyl ether diisocyanate, triphenylmethane triisocyanate. Preferably, the polyisocyanate includes at least one of hexamethylene diisocyanate, isophorone diisocyanate, norbornane diisocyanate, 4,4′-diisocyanate dicyclohexylmethane, m-xylylenediisocyanate and hydrogenated xylylene diisocyanate. More preferably, the polyisocyanate includes at least one of hydrogenated xylylene diisocyanate, norbornane diisocyanate and m-xylylenediisocyanate.

In some embodiments of the present invention, the molar ratio of —SH in the polythiol composition to —NCO in the polyisocyanate is 0.8:1 to 1.2:1, such as 1:1.

In some embodiments of the present invention, the material a further includes a third polythiol compound.

The third polythiol compound includes at least one of 4,7-dimercaptomethyl-1,11 -dimercapto-3,6,9-trithiaundecane, 4,8-dimercaptomethyl-1, 11-dimercapto-3,6,9-trithiaundecane, 5,7-dimercaptomethyl-1, 11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy) ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis(3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)yclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl) propane, 4,4′-dimercaptobiphenyl, bis(4-mercaptophenyl) ether, bis(4-mercaptomethylphenyl)methane, 1,1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole and 3,4-thiophenedithiol.

In some embodinents of the present invention, the mass ratio of the polythiol composition to the third polythiol compound is (0.5:1)-(2:1), such as 1.8:1 and 1.1:1.

In some embodinents of the present invention, the catalyst includes at least one of dibutyltin dilaurate, dibutyltin dichloride, dibutyltin oxide, or stannous octanoate. Preferably, the catalyst includes dibutyltin dilaurate or dibutyltin dichloride.

In some embodinents of the present invention, the mass ratio of the catalyst to the material a is (0.005-0.2):100, preferably (0.01-0.1):100.

In the present invention, if the mass ratio of the catalyst to the material a is less than 0.005%, it may cause incomplete polymerization, thereby causing poor mechanical properties of the optical material. If the mass ratio of catalyst to the material a is greater than 0.2%, the polymerization speed may be too fast, causing the color tone of the optical material to rise.

In some embodinents of the present invention, the raw material for preparing the optical material further includes an auxiliary agent. The auxiliary agent includes at least one of a release agent, an ultraviolet absorber and a toner.

In some embodinents of the present invention, the release agent is polyphosphate. The mass ratio of the release agent to the material a is (0.005-0.2):100, preferably (0.01-0.1): 100.

In some embodiments of the present invention, the optical material is an optical lens.

The present invention also provides a method for preparing the optical material described above, including the steps of:
Mixing the raw material including material a and the catalyst, and polymerizing and curing to obtain an optical material;
The material a includes a polythiol composition and a polyisocyanate.

The polythiol composition is the polythiol composition described above.

The raw material components and ratio thereof used in the preparation method of the optical material are the same as above and will not be described in detail here.

In some embodinents of the present invention, the method for preparing the optical material including the steps of:
A) Stirring and dissolving the polyisocyanate, catalyst and release agent to obtain a first mixed solution;
B) Uniformly mixing the first mixed solution, the polythiol composition and the third polythiol compound, and degassing to obtain a second mixed solution;
C) Pouring the second mixed solution into a mold, and polymerizing and curing to obtain the optical material;

The polythiol composition is the polythiol composition described above.

### In Step A):

The temperature for stirring and dissolving is 10-20° C.

### In Step B):

A vacuum pump is used for degassing, the pressure is controlled below 350 Pa, and the degassing time is 0.5-1.0h.

### In Step C):

The mold is a glass mold with a diameter of 80 mm, a thickness of 10 mm and a curved surface of 0°.

After the pouring, the method further includes that: placing the mold flat on a tray.

In some embodinents of the present invention, the heating process for the polymerizing and curing includes:
Keep the temperature at 25-35° C. for 175-185 min, raise the temperature to 43-47° C. at a rate of 0.83-1.25° C./10 min, then raise the temperature to 48-52° C. at a rate of 0.42-0.56° C./10 min, then raise the temperature to 58-62° C. at a rate of 0.57-0.83° C./10 min, and then raise the temperature to 115-125° C. at a rate of 2.00-2.50° C./10 min, and keep the temperature at 115-125° C. for 180-240 min.

In some embodinents, the heating process for the polymerizing and curing includes:
Keep the temperature at 30° C. for 180 min, raise the temperature to 45° C. at a rate of 1.25° C./10 min, then raise the temperature to 50° C. at a rate of 0.56° C./10 min, then raise the temperature to 60° C. at a rate of 0.83° C./10 min, and then raise the temperature to 120° C. at a rate of 2.50° C./10 min, and keep the temperature at 120° C. for 180 min.
Or
Keep the temperature at 30° C. for 180 min, raise the temperature to 45° C. at a rate of 0.83° C./10 min, then raise the temperature to 50° C. at a rate of 0.42° C./10 min, then raise the temperature to 60° C. at a rate of 0.57° C./10 min, and then raise the temperature to 120° C. at a rate of 2.00° C./10 min, and keep the temperature at 120° C. for 240 min.

In some embodiments of the present invention, after the polymerization and curing, the method further includes: cooling. The temperature after cooling is 75-85° C., such as 80° C.; and the cooling time is 115-125 min, such as 120 min.

The present invention has no particular limitation on the sources of the raw materials used above, and the raw materials can generally be commercially available.

The polythiol composition provided by the present invention can significantly improve the material leakage condition after pouring during the preparation of optical materials. By further limiting the mass ratio of the first polythiol compound having the structure as shown in formula I and the second polythiol compound having the structure as shown in formula II, the material leakage rate after pouring can be significantly reduced, while the refractive index is not significantly reduced, thereby improving the application performance of the polythiol.

In order to further illustrate the present invention, a polythiol composition and the use thereof provided by the present invention are described in detail below in conjunction with the embodiments, but it should not be understood as limiting the protection scope of the present invention.

### EMBODIMENT 1

Preparation for the first polythiol compound having the structure as shown in formula I:

117.5 g (1.5 mol) of mercaptoethanol was added to a four-necked flask equipped with a thermometer, a stirrer and a constant-pressure dropping funnel, and 193.8 g (1.55 mol of sodium hydroxide) of sodium hydroxide solution with the mass concentration of 32% was added dropwise, and the mixture was stirred at 35° C. for 30 min;

Then 73.8 g (0.5 mol) of 1,2,3-trichloropropane was added dropwise, and the temperature was controlled at 45° C. during the dropwise addition, and after the dropwise addition was completed, the reaction was carried out at 40° C. for 2 h;

Then 197.5 g (2 mol of hydrochloric acid) of hydrochloric acid solution with the concentration of 37.0% and 122.5 g of thiourea (1.6 mol) were added into the four-necked flask, and the temperature was raised to 120° C. for the reflux reaction for 4 h;

The temperature was lowered to 25° C., 236 g (2.5 mol of ammonia) of ammonia solution with the mass concentration of 18% was added, and then the temperature was raised to 65° C. for reaction for 3 h. After the reaction was completed, liquid separation was carried out, the lower-layer crude product was transferred to a single-necked flask, and ethanol of the same mass as the crude product was added for washing for three times. After the washing was completed, the crude product was desolventized in vacuum to obtain 132 g of the first polythiol compound having the structure as shown in formula I.

### Embodiment 2

The first polythiol compound having the structure as shown in formula I and the second polythiol compound having the structure as shown in formula II were mixed in different proportions to obtain different polythiol compositions.

The mass ratios of the first polythiol compound having the structure as shown in formula I and the second polythiol compound having the structure as shown in formula II (denoted as mI:mII) were 0.4%, 0.6%, 0.8%, 1.0%, 1.5%, 2.0%, 2.5%, 3.0%, 4.0% and 5.0%, respectively.

### COMPARATIVE EMBODIMENT 1

### Preparation of an Optical Material:

52.0 parts by mass of xylylene diisocyanate, 0.01 parts by mass of catalyst (dibutyltin dichloride) and 0.08 parts by mass of mold release agent (polyphosphate) were added into the batching kettle, and stirred and dissolved at 15° C.; then 48.0 parts by mass of the second polythiol compound having the structure as shown in formula II was added, and stirred evenly. The molar ratio of-SH in the second polythiol compound and —NCO in the xylylene diisocyanate was 1:1. A vacuum pump was used for degassing, the pressure was controlled at 350 Pa, and the degassing time was 0.5 h. A mixed solution was prepared and poured into a clean glass mold with a diameter of 80 mm and a thickness of 10 mm and a curved surface of 0°. 1000 molds were poured and placed flat on a tray after the pouring was completed. These molds were placed in an oven for programmed heating and curing (the temperature was kept at 30° C. for 180 min, and then the temperature was raised to 45° C. at a rate of 1.25° C./10 min, then the temperature was raised to 50° C. at a rate of 0.56° C./10 min, then the temperature was raised to 60° C. at a rate of 0.83° C./10 min, and then the temperature was raised to 120° C. at a rate of 2.50° C./10 min, and the temperature was kept at 120° C. for 180 min), and the temperature was lowered to 80° C. over 120 min. Then these molds were taken out and opened to obtain the optical lens.

### APPLICATION EXAMPLES 1-10

The second polythiol compound having the structure as shown in formula II in the comparative embodiment 1 was replaced by the polythiol composition in Embodiment 2, the molar ratio of-SH in the polythiol composition to —NCO in the polyisocyanate was 1:1, and finally an optical lens was prepared.

### COMPARATIVE EMBODIMENT 2

The second polythiol compound having the structure as shown in formula Il in the comparative embodiment I was replaced by the first polythiol compound having the structure as shown in formula I and the second polythiol compound having the structure as shown in formula II, a mass ratio of the first polythiol compound having the structure as shown in formula I and the second polythiol compound having the structure as shown in formula II was 10%; and the molar ratio of-SH in the polythiol composition to —NCO in the polyisocyanate was 1:1, and finally the optical lens was prepared.

The material leakage rate and the refractive index of the optical lens in the application examples 1-10 and the comparative embodiments 1-2 were tested, and the results are as shown in Table 1.

Test method for the material leakage rate: after placing the poured mold in an oven for programmed heating and curing, take out, and test to see if there is any resin solid on the outer surface of the mold. If there is, it is considered as material leakage. The leakage rate is calculated by counting the proportion of the number of leaked materials to the total number.

For the test of refractive index, the brand for the adopted instrument is ATAGO, and the model is NAR-4T.

TABLE 1
Material Leakage Rate and Refractive Index of Optical Lens in
Application Examples 1-10 and Comparative Embodiments 1-2.

| | | Material Leakage | Refractive |
|---|---|---|---|
| | mI:mII | Rate % | Index(Nd) |
| Application | 0.4% | 1.6 | 1.6608 |
| example 1 | | | |
| Application | 0.6% | 1.5 | 1.6607 |
| example 2 | | | |
| Application | 0.8% | 1.4 | 1.6606 |
| example 3 | | | |
| Application | 1.0% | 1.2 | 1.6605 |
| example 4 | | | |
| Application | 1.5% | 1.0 | 1.6603 |
| example 5 | | | |
| Application | 2.0% | 0.8 | 1.6601 |
| example 6 | | | |
| Application | 2.5% | 0.6 | 1.6600 |
| example 7 | | | |
| Application | 3.0% | 0.4 | 1.6598 |
| example 8 | | | |
| Application | 4.0% | 0.2 | 1.6596 |
| example 9 | | | |
| Application | 5.0% | 0.1 | 1.6595 |
| example 10 | | | |
| Comparative | 0% | 4.8 | 1.6609 |
| embodiment 1 | | | |
| Comparative | 10% | 0.1 | 1.6588 |
| embodiment 2 | | | |

### COMPARATIVE EMBODIMENT 3

### Preparation of an Optical Material:

49.8 parts by mass of hydrogenated xylylene diisocyanate, 0.10 parts by mass of catalyst (dibutyltin dichloride) and 0.10 parts by mass of mold release agent (polyphosphate) were added into the batching kettle, and stirred and dissolved at 15° C.; then 30.2 parts by mass of the second polythiol compound having the structure as shown in formula II and 20.0 parts by mass of the third polythiol compound (pentaerythritoltetrakismercaptopropionate) were added, and stirred evenly. The the molar ratio of —SH in the polythiol composition to —NCO in the polyisocyanate was 1:1. A vacuum pump was used for degassing, the pressure was controlled at 350 Pa, and the degassing time was 0.5 h. A mixed solution was prepared and poured into a clean glass mold with a diameter of 80 mm and a thickness of 10 mm and a curved surface of 0°. 1000 molds were poured and placed flat on a tray after the pouring was completed. The material leakage condition of the pouring port was observed, and the material leakage rate was counted. These molds were placed in an oven for programmed heating and curing (the temperature was kept at 30° C. for 180 min, and then the temperature was raised to 45° C. at a rate of 0.83° C./10 min, then the temperature was raised to 50° C. at a rate of 0.42° C./10 min, then the temperature was raised to 60° C. at a rate of 0.57° C./10 min, and then the temperature was raised to 120° C. at a rate of 2.00° C./10 min, and the temperature was kept at 120° C. for 240 min), and the temperature was lowered to 80° C. over 120 min. Then these molds were taken out and opened to obtain the optical lens.

### APPLICATION EXAMPLES 11-20

The second polythiol compound having the structure as shown in formula II in the comparative embodiment 3 was replaced by the polythiol composition in Embodiment 2, the molar ratio of —SH in the polythiol composition to —NCO in the polyisocyanate was 1:1, and finally an optical lens was prepared.

### COMPARATIVE EMBODIMENT 4

The second polythiol compound having the structure as shown in formula II in the comparative embodiment 3 was replaced by the first polythiol compound having the structure as shown in formula I and the second polythiol compound having the structure as shown in formula II, a mass ratio of the first polythiol compound having the structure as shown in formula I and the second polythiol compound having the structure as shown in formula II was 10%; and the molar ratio of —SH in the polythiol composition to —NCO in the polyisocyanate was 1:1, and finally the optical lens was prepared.

The material leakage rate and the refractive index of the optical lens in the application examples 11-20 and the comparative embodiments 3-4 were tested, and the results are as shown in Table 2.

Test method for the material leakage rate: after placing the poured mold in an oven for programmed heating and curing, take out, and test to see if there is any resin solid on the outer surface of the mold. If there is, it is considered as material leakage. The leakage rate is calculated by counting the proportion of the number of leaked materials to the total number.

TABLE 2
Raw Material Ratios of Polythiol Compositions and
Properties of Optical Lenses in Application Examples
11-20 and Comparative Embodiments 3-4.

| | | Material Leakage | Refractive |
|---|---|---|---|
| | mI:mII | Rate % | Index(Nd) |
| Application | 0.4% | 1.2 | 1.5963 |
| example 11 | | | |
| Application | 0.6% | 1.1 | 1.5962 |
| example 12 | | | |
| Application | 0.8% | 1.0 | 1.5961 |
| example 13 | | | |
| Application | 1.0% | 0.8 | 1.5960 |
| example 14 | | | |
| Application | 1.5% | 0.7 | 1.5959 |
| example 15 | | | |
| Application | 2.0% | 0.6 | 1.5957 |
| example 16 | | | |
| Application | 2.5% | 0.5 | 1.5956 |
| example 17 | | | |
| Application | 3.0% | 0.4 | 1.5955 |
| example 18 | | | |
| Application | 4.0% | 0.2 | 1.5953 |
| example 19 | | | |
| Application | 5.0% | 0.1 | 1.5952 |
| example 20 | | | |
| Comparative | 0% | 3.6 | 1.5963 |
| embodiment 3 | | | |
| Comparative | 10% | 0.1 | 1.5948 |
| embodiment 4 | | | |

### APPLICATION EXAMPLE 21

### Preparation of an Optical Material:

22.8 parts by mass of hexamethylene diisocyanate, 10.0 parts by mass of isophorone diisocyanate, 16.0 parts by mass of hydrogenated xylylene diisocyanate, 0.15 parts by mass of catalyst (dibutyltin dichloride) and 0.10 parts by mass of mold release agent (polyphosphate) were added into the batching kettle, and stirred and dissolved at 15° C.; then 33.0 parts by mass of the the polythiol composition (the first polythiol compound having the structure as shown in formula I and the second polythiol compound having the structure as shown in formula II, with a mass ratio of 0.8%) and 18.2 parts by mass of pentaerythritoltetrakismercaptopropionate were added, and stirred evenly. The the molar ratio of —SH in the polythiol composition to —NCO in the polyisocyanate was 1:1. A vacuum pump was used for degassing, the pressure was controlled at 350 Pa, and the degassing time was 0.5 h. A mixed solution was prepared and poured into a clean glass mold with a diameter of 80 mm and a thickness of 10 mm and a curved surface of 0°. 1000 molds were poured and placed flat on a tray after the pouring was completed. These molds were placed in an oven for programmed heating and curing (the temperature was kept at 30° C. for 180 min, the temperature was raised to 45° C. at a rate of 0.83° C./10 min, then the temperature was raised to 50° C. at a rate of 0.42° C./10 min, then the temperature was raised to 60° C. at a rate of 0.57° C./10 min, and then the temperature was raised to 120° C. at a rate of 2.00° C./10 min, and the temperature was kept at 120° C. for 240 min), and the temperature was lowered to 80° C. over 120 min. Then these molds were taken out and opened to obtain the optical lens. The detected refractive index is 1.5958, and the leakage rate is 1.0%.

### APPLICATION EXAMPLE 22

49.6 parts by mass of norbornane diisocyanate, 0.03 parts by mass of catalyst (dibutyltin dichloride) and 0.75 parts by mass of mold release agent (polyphosphate) were added into the batching kettle, and stirred and dissolved at 15° C.; then 25.5 parts by mass of the the polythiol composition (the first polythiol compound having the structure as shown in formula I and the second polythiol compound having the structure as shown in formula II, with a mass ratio of 0.8%) and 23.9 parts by mass of pentaerythritoltetrakismercaptopropionate were added, and stirred evenly. The the molar ratio of —SH in the polythiol composition to —NCO in the polyisocyanate was 1:1. A vacuum pump was used for degassing, the pressure was controlled at 350 Pa, and the degassing time was 0.5 h. A mixed solution was prepared and poured into a clean glass mold with a diameter of 80 mm and a thickness of 10 mm and a curved surface of 0°. 1000 molds were poured and placed flat on a tray after the pouring was completed. These molds were placed in an oven for programmed heating and curing (the temperature was kept at 30° C. for 180 min, and then the temperature was raised to 45° C. at a rate of 0.83° C./10 min, then the temperature was raised to 50° C. at a rate of 0.42° C./10 min, then the temperature was raised to 60° C. at a rate of 0.57° C./10 min, and then the temperature was raised to 120° C. at a rate of 2.00° C./10 min, and the temperature was kept at 120° C. for 240 min), and the temperature was lowered to 80° C. over 120 min. Then these molds were taken out and opened to obtain the optical lens. The detected refractive index is 1.5960, and the leakage rate is 0.9%.

The above description for the disclosed embodiments enable those skilled in this field to implement or use the present invention. Various modifications to these embodiments will be apparent to those skilled in the field, and the general principles defined herein may be implemented in other embodiments without departing from the spirit or scope of the present invention. Therefore, the present invention will not be limited to the embodiments shown herein, but shall conform to the widest scope consistent with the principles and novel features disclosed herein.

What is claimed is:

1-10. (canceled)

11. A use of a polythiol composition in an optical material, wherein the polythiol composition comprises a first polythiol compound having a structure as shown in formula I and a second polythiol compound having a structure as shown in formula II; 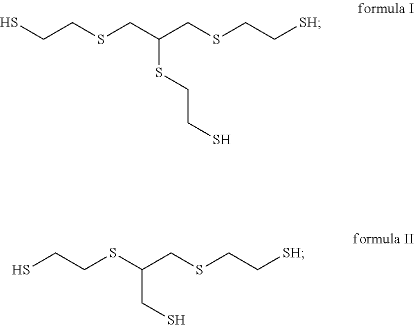 [SMILES: SCCSCC(CSCCS)SCCS ; SCCSCC(CS)SCCS]
a mass ratio of the first polythiol compound having the structure as shown in formula I and the second polythiol compound having the structure as shown in formula II is (0.4-5.0):100.

12. An optical material, wherein the optical material is prepared from a raw material comprising a material a and a catalyst;
the material a comprises a polythiol composition and a polyisocyanate;
the polythiol composition comprises a first polythiol compound having a structure as shown in formula I and a second polythiol compound having a structure as shown in formula II; 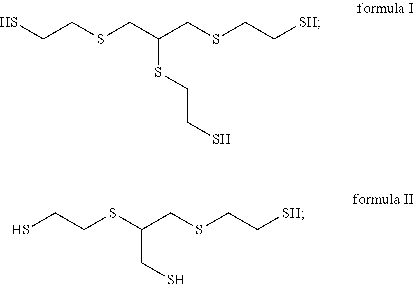 [SMILES: SCCSCC(CSCCS)SCCS ; SCCSCC(CS)SCCS]
a mass ratio of the first polythiol compound having the structure as shown in formula I and the second polythiol compound having the structure as shown in formula II is (0.4-5.0):100.

13. The optical material according to claim 12, wherein the polyisocyanate comprises at least one of tetramethylene diisocyanate, hexamethylene diisocyanate, cyclohexane diisocyanate, 4,4′-diisocyanate dicyclohexylmethane, isophorone diisocyanate, norbornane diisocyanate, xylylene diisocyanate, hydrogenated xylylene diisocyanate, tetramethyl m-xylylene diisocyanate, dithiodipropyl diisocyanate, dithiodiethyl diisocyanate, 2,5-diisocyanatomethylthiophene, 2,5-diisocyanatomethyl-1,4-dithiane, 2,5-diisocyanato-1,4-dithiane, thiodihexyl diisocyanate, thiodipropyl diisocyanate, bis(isocyanatomethyl)adamantane, bis(isocyanatomethyl)tetrahydrothiophene, 2,6-bis(isocyanatomethyl)naphthalene, 1,5-naphthalene diisocyanate, diethylene diisocyanate, trimethylhexamethylene diisocyanate, lysine triisocyanate, tolylene diisocyanate, o-tolidine diisocyanate, diphenylmethane diisocyanate, diphenyl ether diisocyanate, and triphenylmethane triisocyanate.

14. The optical material according to claim 12, wherein a molar ratio of —SH in the polythiol composition to —NCO in the polyisocyanate is 0.8:1 to 1.2:1.

15. The optical material according to claim 12, wherein the material a further comprises a third polythiol compound;
the third polythiol compound comprises at least one of 4,7-dimercaptomethyl-1,11-dimercapto-3,6,9-trithiaundecane, 4,8-dimercaptomethyl-1, 11-dimercapto-3,6,9-trithiaundecane, 5,7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis(3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl) sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl) propane, 4,4′-dimercaptobiphenyl, bis 4-mercaptophenyl) ether, bis(4-mercaptomethylphenyl)methane, 1,1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol;
a mass ratio of the polythiol composition to the third polythiol compound is 0.5:1 to 2:1.

16. The optical material according to claim 12, wherein the catalyst comprises at least one of dibutyltin dilaurate, dibutyltin dichloride, dibutyltin oxide, or stannous octanoate;
a mass ratio of the catalyst to the material a is 0.005-0.2):100.

17. The optical material according to claim 12, wherein the raw material for preparing the optical material further comprises an auxiliary agent;
the auxiliary agent comprises at least one of a release agent, an ultraviolet absorber, and a toner;
the release agent is polyphosphate.

18. A method for preparing the optical material according to claim 12, comprising steps of:
mixing the raw material comprising the material a and the catalyst, and polymerizing and curing to obtain the optical material;
wherein the material a comprises the polythiol composition and the polyisocyanate.

19. The method according to claim 18, wherein the method for preparing the optical material comprises steps of:
A) stirring and dissolving the polyisocyanate, the catalyst, and a release agent to obtain a first mixed solution,
B) uniformly mixing the first mixed solution, the polythiol composition and a third polythiol compound, and degassing to obtain a second mixed solution; and
C) pouring the second mixed solution into a mold, and polymerizing and curing to obtain the optical material;
wherein the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio) ethane, 2,3-dimercapto-1-propanol, 1.2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl) sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis (3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl)propane, 4,4′-dimercaptobiphenyl, bis(4-mercaptophenyl)ether, bis (4-mercaptomethylphenyl)methane, 1,1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol.

20. The method according to claim 18, wherein in the optical material, the polyisocyanate comprises at least one of tetramethylene diisocyanate, hexamethylene diisocyanate, cyclohexane diisocyanate, 4,4′-diisocyanate dicyclohexylmethane, isophorone diisocyanate, norbornane diisocyanate, xylylene diisocyanate, hydrogenated xylylene diisocyanate, tetramethyl m-xylylene diisocyanate, dithiodipropyl diisocyanate, dithiodiethyl diisocyanate, 2,5-diisocyanatomethylthiophene, 2,5-diisocyanatomethyl-1,4-dithiane, 2,5-diisocyanato-1,4-dithiane, thiodihexyl diisocyanate, thiodipropyl diisocyanate, bis(isocyanatomethyl)adamantane, bis(isocyanatomethyl)tetrahydrothiophene, 2,6 bis(isocyanatomethyl)naphthalene, 1,5-naphthalene diisocyanate, diethylene diisocyanate, trimethylhexamethylene diisocyanate, lysine triisocyanate, tolylene diisocyanate, o-tolidine diisocyanate, diphenylmethane diisocyanate, diphenyl ether diisocyanate, and triphenylmethane triisocyanate.

21. The method according to claim 18, wherein in the optical material, a molar ratio of —SH in the polythiol composition to —NCO in the polyisocyanate is 0.8:1 to 1.2:1.

22. The method according to claim 18, wherein in the optical material, the material a further comprises a third polythiol compound;
the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis(2-mercaptoethyl) ether, tetrakis(mercaptomethyl)methane, 1,2-dimercaptopropane, 1,3-dimercaptopropane, 1,4-dimercaptobutane, 1,6-dimercaptohexane, 2,2-dimercaptopropane, 1,2-bis(2-mercaptoethyloxy) ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl) sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis(3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis (4-mercaptophenyl) sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4 bis(mercaptomethyl)benzene, 2,2′-dimercaptobiphenyl, bis(4-mercaptophenyl)methane, 2,2-bis(4-mercaptophenyl) propane, 4,4′-dimercaptobiphenyl, bis (4-mercaptophenyl) ether, bis(4-mercaptomethylphenyl) methane, 1,1,3,3-tetrakis(mercaptomethylthio)propane, 2,2-bis (4-mercaptomethylphenyl) propane, bis(4-mercaptomethylphenyl)ether, bis4-mercaptomethylphenyl) sulfide, 2,5-dimercapto-1,3,4-thiadiazole, and 3,4-thiophenedithiol;
a mass ratio of the polythiol composition to the third polythiol compound is 0.5:1 to 2:1.

23. The method according to claim 18, wherein in the optical material, the catalyst comprises at least one of dibutyltin dilaurate, dibutyltin dichloride, dibutyltin oxide, or stannous octanoate;
a mass ratio of the catalyst to the material a is (0.005-0.2):100.

24. The method according to claim 18, wherein in the optical material, the raw material for preparing the optical material further comprises an auxiliary agent;
the auxiliary agent comprises at least one of a release agent, an ultraviolet absorber, and a toner;
the release agent is polyphosphate.

25. The method according to claim 20, wherein the method for preparing the optical material comprises steps of:
A) stirring and dissolving the polyisocyanate, the catalyst, and a release agent to obtain a first mixed solution;
B) uniformly mixing the first mixed solution, the polythiol composition and a third polythiol compound, and degassing to obtain a second mixed solution; and
C) pouring the second mixed solution into a mold, and polymerizing and curing to obtain the optical material:
wherein the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis (2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis (2-mercaptoethyloxy) ethane, 1,2-bis(2-mercaptoethylthio) ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl) sulfide, ethyleneglycolbis (3-mercaptopropionate), diethyleneglycolbis(2-mercaptoacetate), ethyleneglycolbis (2-mercaptoacetate), 1,4-buthanediolbis(2-mercaptoacetate), trimethylolpropanetrismercaptopropionate, pentaerythritoltetrakismercaptoacetate, diethyleneglycolbis (3-mercaptopropionate), pentaerythritoltetrakismercaptopropionate, 1,2-dimercaptocyclohexane, 1,1,1-tris(mercaptomethyl)propane, 1,4-buthanediolbis (3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis(4-mercaptophenyl) sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl) sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl) propane, 4,4′-dimercaptobiphenyl, bis(4-mercaptophenyl)ether, bis (4-mercaptomethylphenyl)methane, 1, 1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol.

26. The method according to claim 21, wherein the method for preparing the optical material comprises steps of:
A) stirring and dissolving the polyisocyanate, the catalyst, and a release agent to obtain a first mixed solution;
B) uniformly mixing the first mixed solution, the polythiol composition and a third polythiol compound, and degassing to obtain a second mixed solution; and
C) pouring the second mixed solution into a mold, and polymerizing and curing to obtain the optical material;
wherein the third polythiol compound comprises at least one of 4,7-dimercaptomethyl-1,11-dimercapto-3,6,9-trithiaundecane, 4,8-dimercaptomethyl-1, 11-dimercapto-3,6,9-trithiaundecane, 5. 7-dimercaptomethyl-1, 11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis (3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoetbyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl)propane, 4,4′-dimercaptobiphenyl, bis(4-mercaptophenyl)ether, bis (4-mercaptomethylphenyl)methane, 1, 1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol.

27. The method according to claim 22, wherein the method for preparing the optical material comprises steps of:
A) stirring and dissolving the polyisocyanate, the catalyst, and a release agent to obtain a first mixed solution;
B) uniformly mixing the first mixed solution, the polythiol composition and the third polythiol compound, and degassing to obtain a second mixed solution; and
C) pouring the second mixed solution into a mold, and polymerizing and curing to obtain the optical material;
wherein the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis(3-mercaptopropionate), pentaerythritoltetrakismercaptopropionate, 1,2-dimercaptocyclohexane, 1,1,1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bismercaptomethyl)cyclohexane, 1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl) propane, 4,4′-dimercaptobiphenyl, bis(4-mercaptophenyl)ether, bis (4-mercaptomethylphenyl)methane, 1,1,3,3-tetrakis(mercaptomethylthio)propane, 2,2-bis(4-mercaptomethylphenyl)propane, bis(4-mercaptomethylphenyl) ether, bis(4-mercaptomethylphenyl)sulfide, 2,5-dimercapto-1,3,4-thiadiazole, and 3,4-thiophenedithiol.

28. The method according to claim 23, wherein the method for preparing the optical material comprises steps of:
A) stirring and dissolving the polyisocyanate, the catalyst, and a release agent to obtain a first mixed solution;
B) uniformly mixing the first mixed solution, the polythiol composition and a third polythiol compound, and degassing to obtain a second mixed solution; and
C) pouring the second mixed solution into a mold, and polymerizing and curing to obtain the optical material;
wherein the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)thane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis(2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis (3-mercaptopropionate), pentaerythritoltetrakismercaptopropionate, 1,2-dimercaptocyclohexane, 1,1,1-tris(mercaptomethyl)propane, 1,4-buthanediolbis (3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl)propane, 4,4′-dimercaptobiphenyl, bis(4-mercaptophenyl)ether, bis(4-mercaptomethylphenyl)methane, 1,1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol.

29. The method according to claim 24, wherein the method for preparing the optical material comprises steps of:
A) stirring and dissolving the polyisocyanate, the catalyst, and the release agent to obtain a first mixed solution;
B) uniformly mixing the first mixed solution, the polythiol composition and a third polythiol compound, and degassing to obtain a second mixed solution; and
C) pouring the second mixed solution into a mold, and polymerizing and curing to obtain the optical material;
wherein the third polythiol compound comprises at least one of 4,7-dimercaptomethyl-1,11-dimercapto-3,6,9-trithiaundecane, 4,8-dimercaptomethyl-1,11-dimercapto-3,6,9-trithiaundecane, 5,7-dimercaptomethyl-1,11-dimercapto-3,6,9-trithiaundecane, methanedithiol, methanetrithiol, bis(2-mercaptoethyl)ether, tetrakis(mercaptomethyl)methane, 1,2-dimercaptopropane; 1,3-dimercaptopropane, 1,4-dimercaptobutane, 1,6-dimercaptohexane, 2,2-dimercaptopropane, 1,2-bis(2-mercaptoethyloxy)ethane, 1,2-bis(2-mercaptoethylthio)ethane, 2,3-dimercapto-1-propanol, 1,2-dimercaptoethane, 1,3-dimercapto-2-propanol, 2-mercaptomethyl-1,3-dimercaptopropane, 2-mercaptomethyl-1,4-dimercaptobutane, 1,2,3-trimercaptopropane, 2-(2-mercaptoethylthio)-1,3-dimercaptopropane, 2,4-dimercaptomethyl-1,5-dimercapto-3-thiapentane, bis(2-mercaptoethyl)sulfide, ethyleneglycolbis(3-mercaptopropionate), diethyleneglycolbis 2-mercaptoacetate), ethyleneglycolbis(2-mercaptoacetate), 1,4-buthanediolbis(2-mercaptoacetate), trimethylolpropanetrismercaptopropionate, pentaerythritoltetrakismercaptoacetate, diethyleneglycolbis (3-mercaptopropionate), pentaerythritoltetrakismercaptopropionate, 1,2-dimercaptocyclohexane, 1,1, 1-tris(mercaptomethyl)propane, 1,4-buthanediolbis(3-mercaptopropionate), 1,3-dimercaptocyclohexane, trimethylolpropanetrismercaptoacetate, 1,4-dimercaptocyclohexane, 1,3-bis(mercaptomethyl)cyclohexane, 1,4-bis(mercaptomethyl)cyclohexane, bis(4-mercaptophenyl)sulfone, 2,5-dimercaptomethyl-1,4-dithiane, 2,5-bis(2-mercaptoethylthiomethyl)-1,4-dithiane, 2,5-dimercaptomethyl-1-thiane, 2,5-dimercaptoethyl-1-thiane, 2,5-dimercaptomethylthiophene, bis(4-mercaptophenyl)sulfide, 1,2-dimercaptobenzene, 1,3-dimercaptobenzene, 1,4-dimercaptobenzene, 1,3-bis(mercaptomethyl)benzene, 2,5-dimercaptomethyl-1,4-dithiane, 1,4-bis(mercaptomethyl)benzene, 2,2′-dimercaptobiphenyl, bis(4-mercaptophenyl)methane, 2,2-bis(4-mercaptophenyl)propane, 4,4′-dimercaptobiphenyl, bis(4-mercaptophenyl) ether, bis(4-mercaptomethylphenyl)methane, 1,1,3,3-tetrakis(mercaptomethylthio)propane, 2,2-bis(4-mercaptomethylphenyl)propane, bis(4-mercaptomethylphenyl)ether, bis(4-mercaptomethylphenyl)sulfide, 2,5-dimercapto-1,3,4-thiadiazole, and 3,4-thiophenedithiol.
